(19) United States
(12) Patent Application Publication
(10) Pub. No.: US 2012/0253988 A1
(43) Pub. Date: Oct. 4, 2012

(54) METHODS AND SYSTEMS FOR PROVIDING INTERACTIVE STOREFRONTS

(76) Inventor: David Pyrzenski, Huntington Beach, CA (US)

(21) Appl. No.: 13/433,353

(22) Filed: Mar. 29, 2012

Related U.S. Application Data
(60) Provisional application No. 61/516,208, filed on Apr. 1, 2011.

(51) Int. Cl. G06Q 30/00; G06T 15/00

(52) U.S. Cl. 705/27.1; 345/419

(57) ABSTRACT

A system comprising a networked server; a business establishment database adapted to store descriptive data describing a plurality of business establishments; a business user interface module configured to allow a business user to submit a descriptive data that is configured to be transmitted to the business establishment database; a customer interface module configured to allow a customer to mark a business establishment; a customer database configured to store a customer's profile comprising a list of business establishments marked via the customer interface module; a linking module connected to the business establishment database and the customer database, the linking module configured to link the marked business establishment to the customer's profile and the customer; and a set of programming codes configured to allow a browser that connects to the server to display the descriptive data and a portion of the customer's profile that marked the business establishment.

### CROSS REFERENCES TO RELATED APPLICATIONS

This application claims the benefit of Provisional Patent Application Ser. No. 61/516,208 filed on Mar. 30, 2011 titled Methods and Systems for Providing Interactive Storefronts.

### FIELD OF INVENTION

The present invention relates to data processing systems and methods, and in particular, computer graphics processing and selective visual display systems for providing interactive storefronts.

### BACKGROUND

Conventional business establishments, such as restaurants or retail stores, typically use websites to describe their products or services. These websites typically include a “Contact Us” page, where an establishment's hours of operation, phone numbers, email addresses, physical address, and mailing address may be listed. These websites may also include an “About Us” page, which may talk about the history of the establishment, its mission statement, or its accomplishments. Product descriptions, features, and photos may also be included in these websites.

Prospective customers may have to visit another website to see reviews of the products or services of the establishment. For instance, customers may have to visit www.yelp.com or blogs to know about the quality of service the establishment renders. Some prospective customers may be fortunate to have somebody they know post their comments about a product or a service on social networks. Nevertheless, these prospective customers still have to switch from one website to another.

Conventional websites may also not be updated instantly. Website owners may have to rely on web designers to make updates. This makes websites serve as impractical tools for instantly announcing events and promotions. Thus, many restaurants may not be able to use their websites to make virtual announcements about their special menu for the day. Many establishments are not able to use their websites to make announcements about their special sale, promotion, or events.

Conventional website owners may also find it challenging to optimize their websites so that they are easily found by search engines. They may also find that it takes plenty of time and expense before they can be on the first page of search engines when web surfers type in the keywords that website owners desire. Thus, there is a demand for a centralized and interactive system for accessing information about a business establishment wherein the manner of access is quick and easy and the information being accessed is current, comprehensive, and practical. There is further a demand by business owners to make them easily visible on-line.

### BRIEF DESCRIPTION OF THE PREFERRED EMBODIMENTS OF THE PRESENT INVENTION

The present invention includes a system comprising a computer server connected to a network; a business establishment database in communication with the computer server and adapted to store descriptive data describing a plurality of business establishments; a business user interface module configured to allow a business user to submit descriptive data describing a business establishment over the network, the business user interface module being in communication with the business establishment database, the descriptive data describing a business establishment being transmitted from the business user interface module to the business establishment database; a customer interface module configured to allow a business establishment customer to mark a business establishment; a customer database in communication with the customer interface module and configured to store a customer's profile, the customer's profile comprising a list of marked business establishments via the customer interface module; a linking module connected to the business establishment database and the customer database, the linking module configured to link the marked business establishment to the customer's profile and the customer; and a set of programming codes in communication with the server and configured to allow a browser that connects to the network and the server to display the descriptive data describing one of the plurality of business establishments and a portion of the customer's profile that marked the business establishment.

The above description sets forth, rather broadly, a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways.

### BRIEF DESCRIPTION OF THE DRAWINGS

FIG. 1a is substantially a schematic illustration showing the systems architecture and communications link between the computers in an embodiment of the present invention.

FIG. 1b is substantially a more detailed schematic illustration of the systems architecture of FIG. 1a.

FIG. 2 is substantially a schematic illustration of a map of an area provided by an embodiment of the present invention.

FIG. 3 is substantially a schematic illustration showing another view of the area shown in FIG. 2.

FIG. 4 is substantially a schematic illustration showing yet another view of the area shown in FIGS. 2 and 3.

FIG. 5 is substantially a screen shot of an introduction webpage preferably displayed before a user logs-in in an embodiment of the present invention.

FIG. 6 is substantially a screen shot of an individual user account creation webpage in an embodiment of the present invention.

FIG. 7 is substantially a screen shot of a business user account creation webpage in an embodiment of the present invention.

FIG. 8 is substantially a screen shot of a webpage preferably displayed after the user logs-in in an embodiment of the present invention.

FIG. 9 is substantially a screen shot of a webpage preferably displayed when a user navigates through the map in an embodiment of the present invention.

FIG. 10 is substantially a screen shot of a webpage preferably displayed when a user wants to obtain information on a selected establishment in an embodiment of the present invention.

FIG. 11 is substantially a screen shot of a webpage preferably displayed when a user wants to obtain additional information on a selected establishment in an embodiment of the present invention.

FIG. 12 is substantially a screen shot of an individual user account management webpage in an embodiment of the present invention.

FIG. 13A is substantially a partial screen shot of a business user account management webpage in an embodiment of the present invention.

FIG. 13B is substantially a partial screen shot of a business user account management webpage in an embodiment of the present invention.

FIG. 14 is substantially a flowchart illustrating the operation of a user log-in process in an embodiment of the present invention.

FIG. 15 is substantially a flowchart illustrating the operation of a user ID and password administration in an embodiment of the present invention.

FIG. 16 is substantially a flowchart illustrating the operation of a business account set-up process in an embodiment of the present invention.

FIG. 17 is substantially a flowchart illustrating the use of an embodiment of the present invention.

FIG. 18 is substantially a flowchart illustrating the operation of an individual user account administration in an embodiment of the present invention.

FIG. 19 is substantially a flowchart illustrating the operation of a business user account administration in an embodiment of the present invention.

### DESCRIPTION OF THE PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. Also, it is to be understood that the phraseology and terminology employed herein are for the purpose of description and should not be regarded as limiting. The term “storefront” is interchangeable used with the terms “establishment,” “business,” or “commercial establishments.” These terms shall mean a place of business with its furnishings and staff or places where dealings or transactions of an economic nature take place.

In one embodiment, the present invention provides a highly informative map of a selected area of a location. The selected area may be a block in a city or a selected street. Selected areas may also include airports, cruise ships, malls, college campuses, recreational/theme parks, and other locations where there are high concentrations of visitors and consumers. The map preferably renders a three-dimensional view of the selected area, including the business establishments in the selected area. The present invention preferably includes various navigation tools that allow for fast and informative navigation.

Certain embodiments of the present invention may serve as an effective tool in promoting business establishments. Certain embodiments of the present invention may make it easier for prospective customers to find and know more about a business establishment that may not be as visible as an establishment in a highly visible location, such as a corner location. For instance, with certain embodiments of the present invention, customers may find it easier to locate and know more about businesses that are located in the middle of a city block, or businesses located in the middle and upper level of a mall or shopping center.

In another embodiment, the map preferably also provides useful, updated, location specific information about the area and participating establishments in the selected area. By simply browsing through the selected area, the user may be provided with highly practical information, such as events going on in the selected area and the business hours of the establishments in the selected area. The user may highlight or select an establishment to obtain even more detailed information, such as the people who are in the establishment, the most up-to-date menu, calendar of events, pictures, and link to the establishment's website.

In another embodiment, the present, invention provides interactive storefronts wherein authorized representatives of business establishments may customize the information about their stores. Authorized representatives may be provided with secure log in information to access administration rights to their virtual storefronts. The authorized representatives may update their business logos, photos, videos, store descriptions, events calendar, promotions or specials, product or services descriptions, including menus for restaurant establishments, website URLs, links to their preferred social networks, and account access preferences.

In certain embodiments, the storefronts are preferably interactive from the consumer standpoint. The storefronts may allow consumers to create their account profiles wherein consumers can, as examples, upload their photos or videos, upload their list of friends or invite friends, build their lists of favorite places, pick a top spot among their favorite places in a particular location, their personal calendars, their home screen display preference, their content view, and include links to their social networking sites. Both the consumers and authorized representatives of business establishments may be given the ability to repast calendar entries on many social media sites.

In another embodiment, the present invention may store usage statistics that may serve as a helpful marketing tracking tool for business establishments. In yet another embodiment, the present invention may serve as a marketplace for artists and entertainers to look for open time slots for performances and apply to perform in those spots.

Thus, it can be appreciated that certain embodiments of the present invention provide a website that may likely attract both new and repeat visitors who may find the website as a very useful planning tool, especially in making their social and recreational plans. Certain embodiments provide business establishments with a way to complement their websites and instantly update the public with their promotions or events.

Systems Architecture and Communications

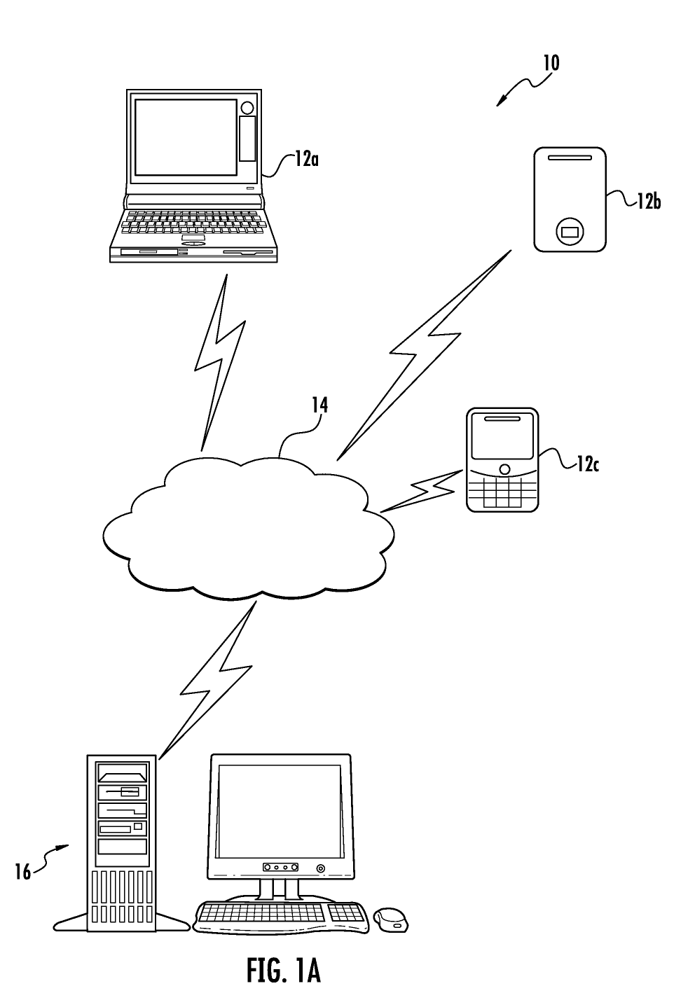

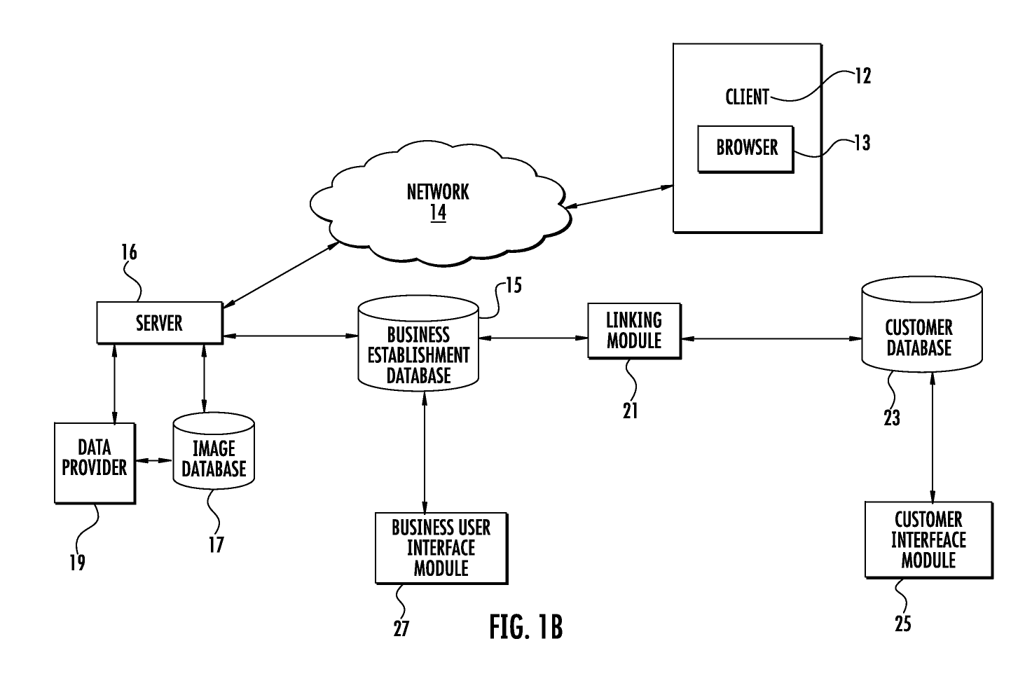

With reference now to FIG. 1a, the interactive storefronts of the present invention are preferably implemented electronically via a system 10, which preferably includes a plurality of client computers 12a-c and a server computer 16 interconnected via a network 14, such as a local area network (intranet) or a wide area network (or the internet). Each of the plurality of client computers 12a-c may include a display unit, a processor, a memory, and an input device, such as a mouse, keyboard, or a touch screen. The client computers 12a-c may be of various forms, such as laptop computers, netbook computers, desktop computers, computers in smartphones, computers in tablets, and computers in mobile devices. The plurality of client computers 12a-c may include a computer usable by a customer and a computer usable by a business.

Referring now to FIG. 1b, the client computers 12 preferably include a browser 13 that can transmit, receive, interpret, and display data received from the server 16 through the network 14. The browser 13 is preferably configured to allow users to avail of the features of the present invention as further described below. The server computer 16 may store various computer programs or programming codes that may be executed and databases that may be accessed for information storage and retrieval to promote the features of the present invention, as described below.

In one embodiment, the system may include a business establishment database 15 and a customer database 23 that may be configured to store various information generated from executing the programs, such as the profiles and information of the business establishment and the customer, respectively. A business user interface module 27 may be provided, which may be a set of programming codes that provide a form for business users to input their information. A customer interface module 25 may also be provided to provide a form for customers to input their information and build their profiles. The information provided from these modules can be transmitted to their respective databases. Both the business establishment database 15 and the customer database 23 may be used for data storage, data referencing, statistics keeping, and report generation, as further described below. In other embodiments, another module and database (not shown) may be created for statistics keeping and report generation. A linking module 21 may be provided to combine related information between a customer and a business establishment so that certain programming codes can show the related information to the browsers as further discussed below.

The system may also include an image database 17, which may contain various images of various locations and their respective information. The server may further include a data provider module and interface 19, which may include a software program that allows retrieval and transmission of geographic information, such as maps, images, and geographic information, from third party providers.

Maps

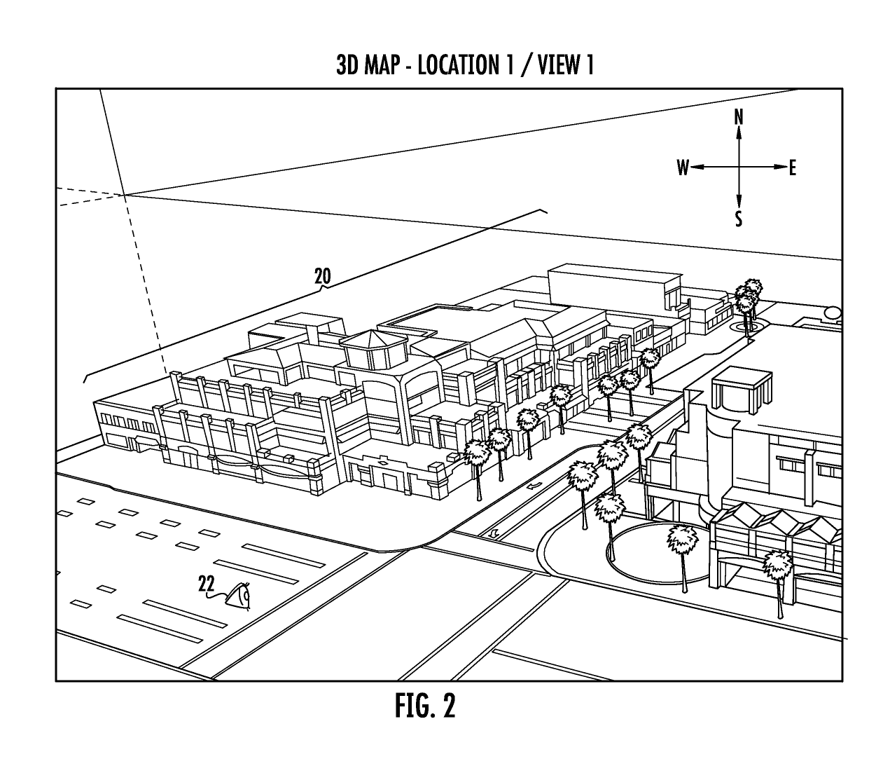

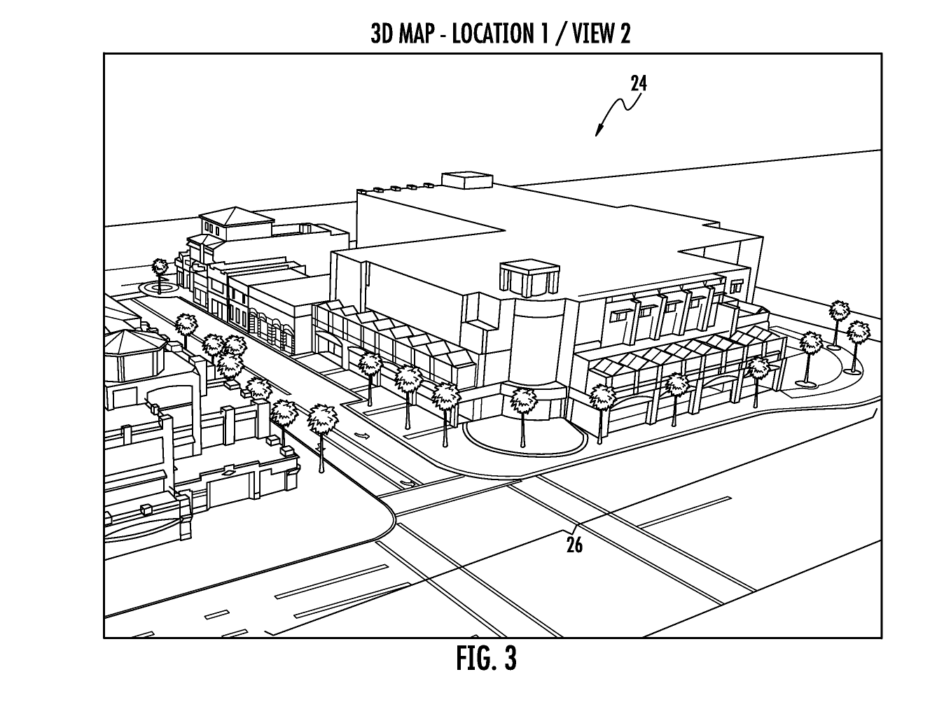

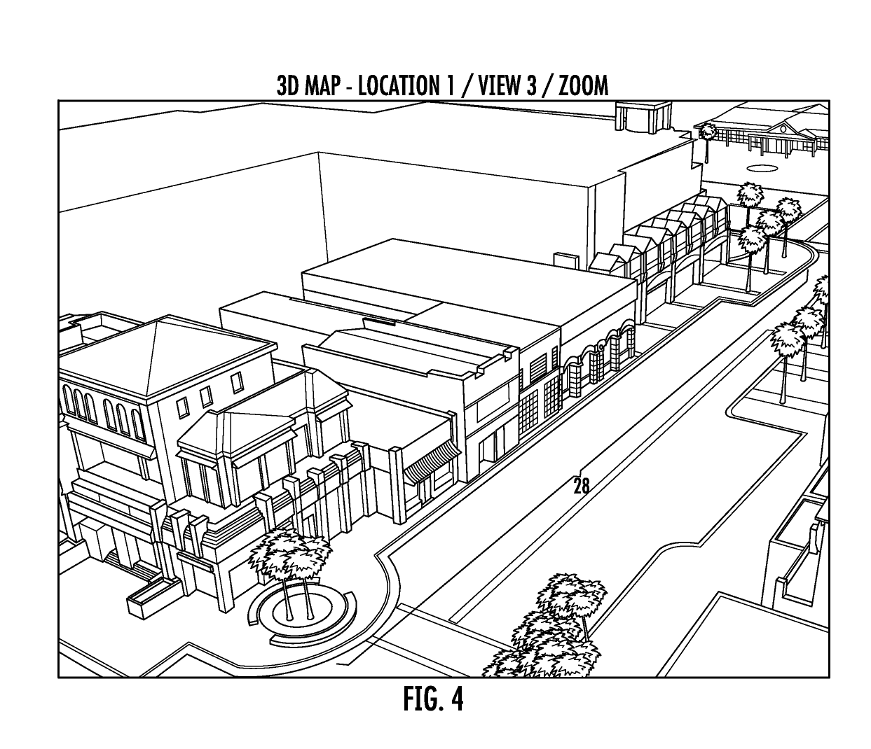

With reference now to FIG. 2, the server computer 16 may store and execute a software program that renders maps preferably with three-dimensional views of business establishments in a selected area of a particular location. These three-dimensional views may individually be created and uploaded into the system. The maps are preferably configurable in format that may easily be displayed on a website, such as HTML. When a client computer 12, through its browser, requests for geographic information, a view of a single area 20 of a location may be displayed at a time. The location may be a city, and the single area may be a selected street in the city or a city block. Multiple different birds' eye view images for each area and for every location may be stored in the image database 17. For instance, a more detailed and closer view 24 of a portion 26 of the single area 20 taken from the northeast viewpoint 22 can be provided and is shown on FIG. 3. Multiple zoom levels for each area are preferably provided. For instance, the portion 26 of the single area 20 can preferably be zoomed-in to focus on the stores on at least one of its sides 28 as shown in FIG. 4.

The present invention is preferably configured to support georeferenced maps and includes the ability to retrieve the latitude and longitude associate with all points on all maps. Certain embodiments preferably provide a mini-map where a user can quickly switch between multiple areas or city blocks within a single location. Certain embodiments may provide a world view or a zoomed out view of a globe wherein a location indicator is placed over each location where detailed information of commercial establishments is available. In one embodiment, the three-dimensional images and their various views are preferably uploaded to the image database 17. In other embodiments, the images, views, and their respective geographic information are obtained from third party providers and are stored in the server 16 via the data provider module and interface 19.

It can be appreciated that with certain embodiments of the present invention, a user may be able to view a particular geographic area from a computer without having to be physically present at the area. Users may be able to gather information about the geographic area, such as things to see or do, and pre-plan their activities. For instance, before coming to a theme park, a user may list and schedule the rides the user wants to go to. The user may also list and schedule the concerts, performances, or parades the user wants to see. Certain embodiments of the present invention further allow users to preview the stores in a location before physically going to the location. By providing the opportunity for consumers to preview stores in a location, the stores that may not be highly visible, such as those located in the middle of a building or those located in the middle level of a multi-story building, may be given a chance to be as visible as the highly visible stores, such as the stores with the corner locations or the stores located on the ground floor. Thus, it can now be realized that the present invention may serve as an effective tool for increasing the visibility of businesses to the consuming public.

Interactive Webpages

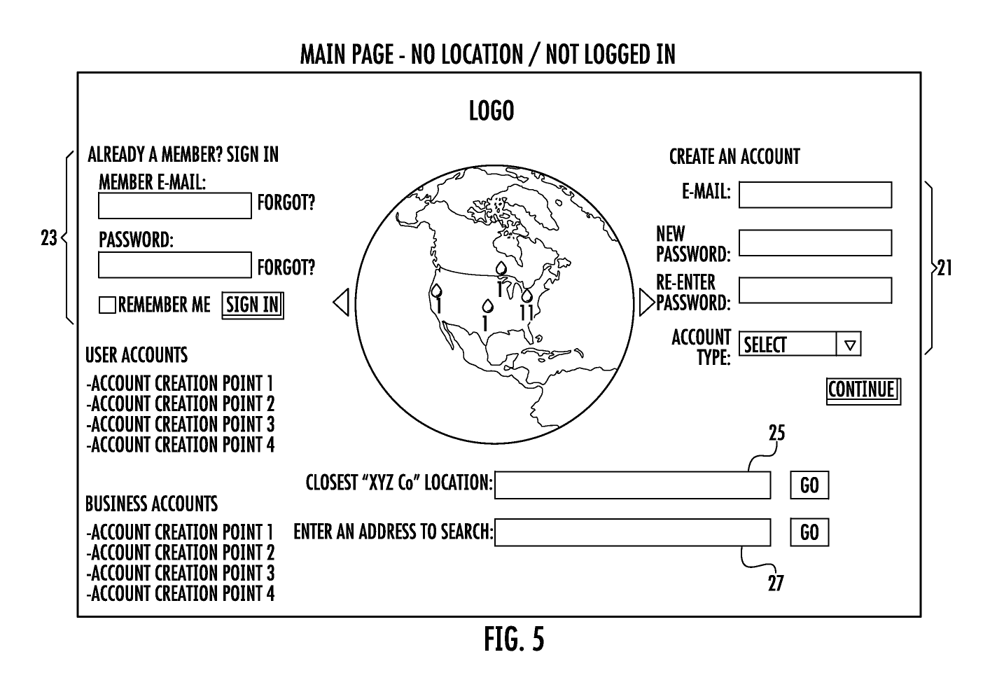

The server 16 preferably stores programming codes adapted to provide an interactive website to the users when the user's browsers connect to the server via the network. The website may prompt a user to log-in. If the user does not have a log-in credential, the user may create an account by answering the questions shown on the account creation section 21 of the webpage (FIG. 5). The system preferably includes an individual user account type and a business user account type. The individual user account type is preferably for users who will likely be consumers or customers of the business establishments or who will use the interactive storefronts of the present invention to obtain information, such as the type of information that would be helpful in planning a visit to the area or location shown. The business user account type is preferably for a business establishment owner or representative who will post information about an establishment, update the information, or obtain statistical information and reports from the system, which may be useful in growing the business. If the user has the log-in credentials, the user may sign-in on the log-in area 23. The user may also indicate a desired location to view on location section 25 or enter an address of a desired location to search on address section 27.

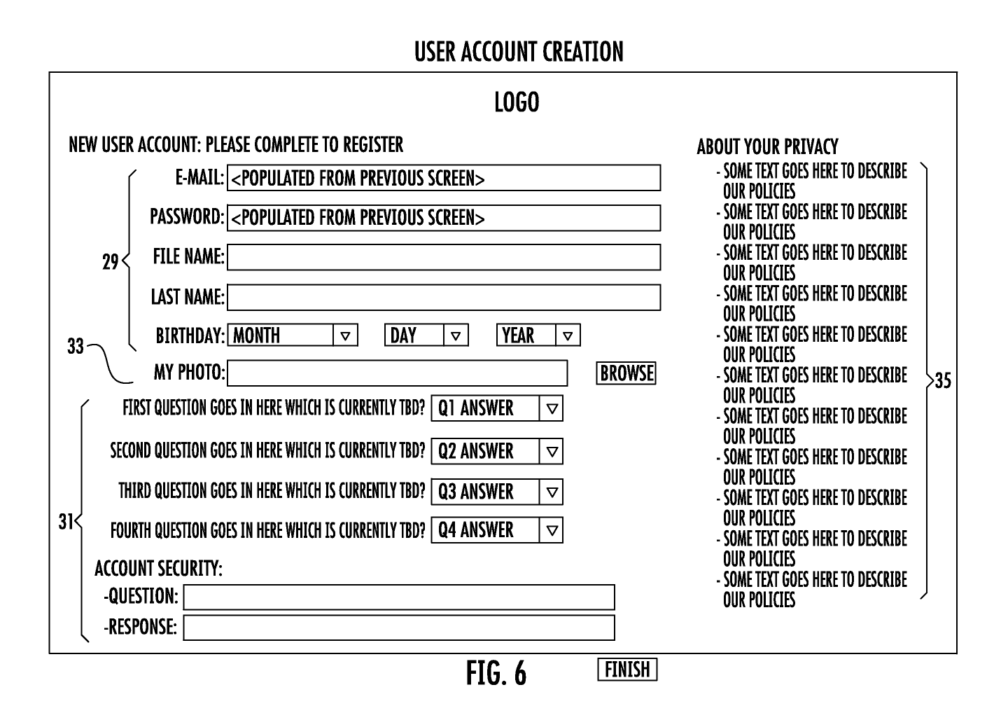

Referring, now to FIG. 6, when a user creates an a individual user account, the user is preferably asked a plurality of biographical questions on biographical section 29 and plurality of security questions and answers on security section 31. The user may be able to upload a personal photo on personal photo section 33. The terms of use for the website may also be provided to the user by displaying legal section 35. It is noted that the user account creation page of FIG. 6 may be provided by the customer interface module 25. The data gathered from the user account creation page may be transmitted to the customer database 23.

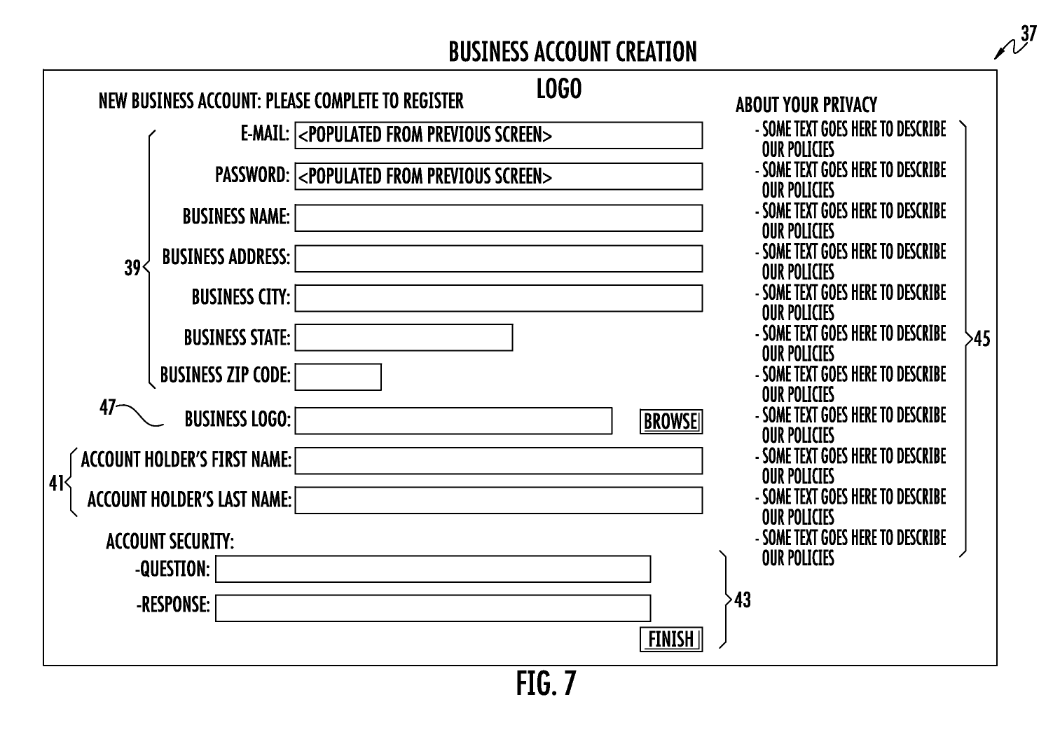

Referring now to FIG. 7, when a user creates a business user account, the user is preferably directed to webpage 37. The user is preferably asked to enter the contact information of the business 39, the first and last name of an authorized business representative 41, and security answers and questions 43. The terms of use for the website may be provided to the user by displaying business legal section 45. The user may upload a business logo to the site by clicking on the browse icon of the business logo section 47. The business account creation page of FIG. 7 may be provided by the business interface module 27, and the data gathered from the business account creation page may be transmitted to the business establishment database 15.

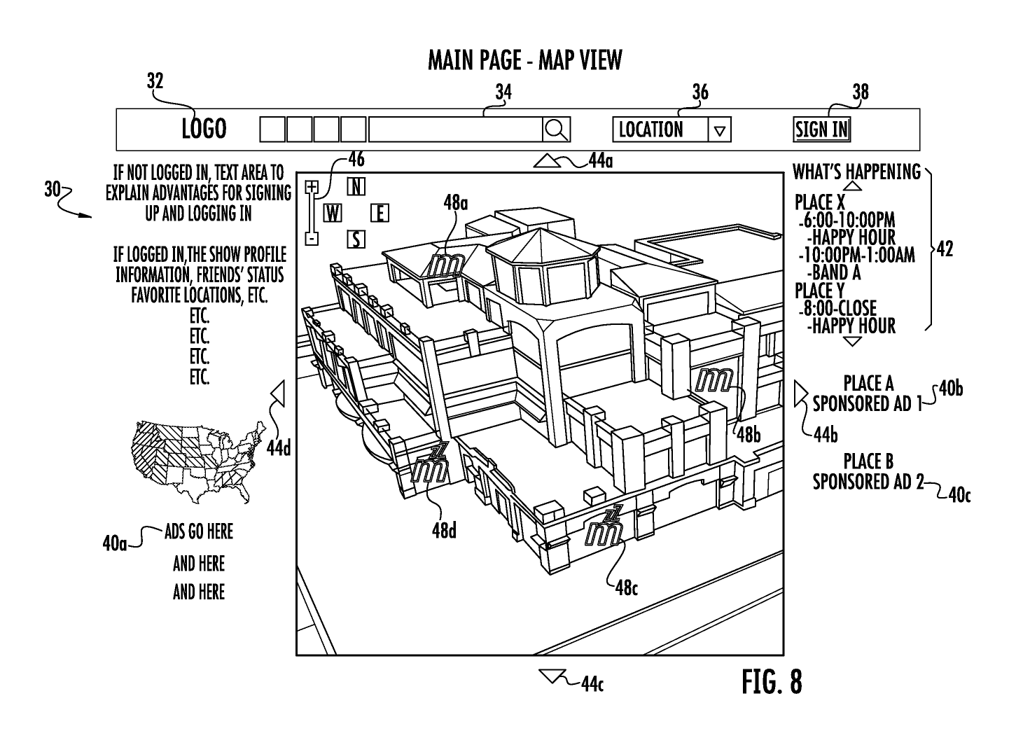

Referring now to FIG. 8, another webpage 30 may include a source identifier 32, such as a business logo, an establishment's name, or a trademark, preferably of the provider of the interactive storefronts, a search box 34, a sign-in icon 38, a location selector 36, a plurality of advertisements 40a, 40b, and 40c, and an event section 42. As an alternative to typing in the name of the desired location on the location selector 36, the user may simply click on a desired area on a locator map 39. The search box 34 may allow users to type in a search query or a keyword that may help the users find the information they are looking for. Users may click on the sign-in icon 38 to log-in and access the various features of the present invention.

The system may include maps and information of various areas of various locations. These available locations are preferably stored and accessible by clicking on the drop down arrow of the location selector 36. Users may click on the drop down arrow of the location selector 36 to pick a desired location. The system may also store information about businesses in various areas of various locations, such as each of the businesses' business hours and events, such as promotional events, holidays, sales events and special business hours. The event section 42 preferably shows a list of business names with their respective business hours and promotional events. A partial list of businesses may be displayed, and a user may be able to scroll up or down to see the complete list of businesses and their respective business hours and promotional events information.

The webpage 30 preferably includes a plurality of store hours indicia 48a-d to indicate whether a business is open or closed in real time, or when the user is using the system. Indicia 48a and 48b may be a predetermined letter, such as letter “m,” to indicate the business is open. Indicia 48c and 48d may be a group of predetermined letters, such as letters “mzZ,” to indicate that the business is closed. Of course, any desired forms of indicia may be used to indicate whether a business is open or closed.

The webpage 30 may also include navigation arrows 44a-d and a zoom adjuster 46 to allow the user to navigate around the area 20 at a desired zoom or detail level. The navigation arrows 44a-d preferably provide navigation based on cardinal directions relative to the current view being displayed. The zoom adjuster 46 may be configured such that each time the zoom in or zoom out button is clicked, the map is zoomed in or zoomed out by, as an example, 1/10 of a step. The zoom adjuster 46 may further be configured such that when the zoom level is at the furthest or closest zoom level, the map is kept at the current view and at its current zoom level. It is noted that certain embodiments preferably are configured to allow users to drag the map and move the map around to see areas in the current view that do not fit into the display window when the zoom level is not at the furthest zoom level. Certain embodiments may further be configured such that when the zoom level is at the furthest zoom level, users may not be allowed to be able to drag the map.

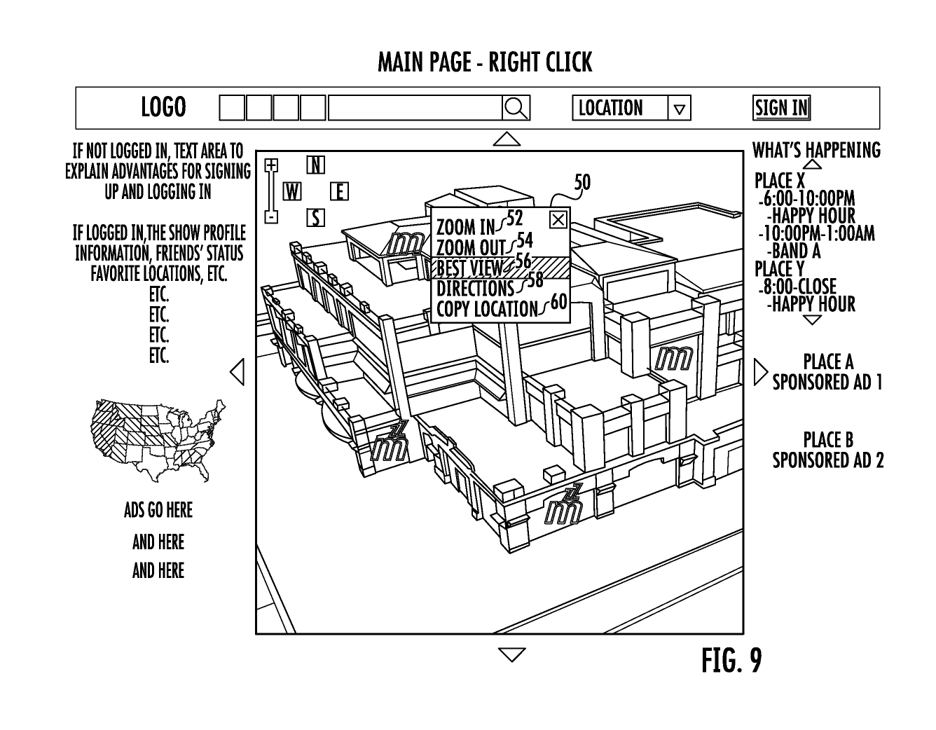

Referring now to FIG. 9, a user may activate an input device, such as by clicking the right side of a mouse, to obtain more navigation options. The list of navigation options preferably appears as a pop-up box 50 and includes the option to zoom-in 52, zoom-out 54, and request for the best view 56. The pop-up box 50 preferably also offers the user to obtain directions to the area selected 58 or to copy the location of the area selected for future reference or use 60. The webpage 30 may also be modified to provide users with a choice to see establishments grouped according to various categories (not shown). For instance, users may be able to select to view only retail establishments, dining establishments, entertainment establishments, or service establishments. Retail establishments may include clothing, apparel, and accessories stores. Dining establishments may include a variety of restaurants from fast food chains to coffee houses to fine dining establishments. Entertainment establishments may include venues for sports events and concerts. They may also include dining establishments that provide entertainment to their patrons, such as live bands. Service establishments may include a variety of service providers, such as beauty salons, spas, pet grooming, dry cleaning, and the like.

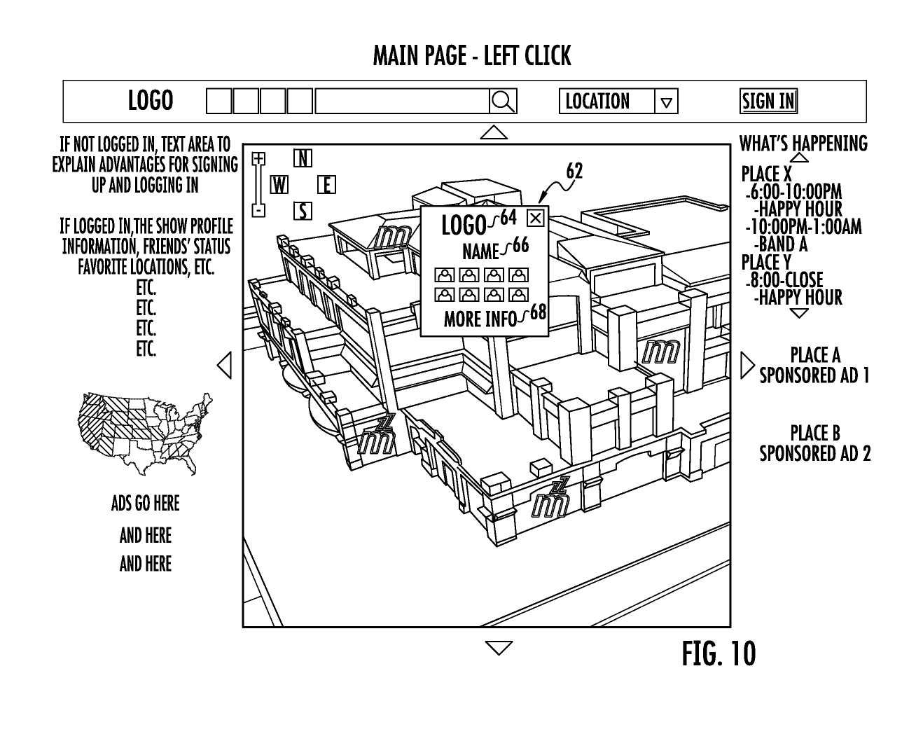

Referring now to FIG. 10, a user may also activate an input device, such as by pointing on a business establishment shown on the map and clicking the left side of a mouse, to obtain more information about the selected business establishment. The list of information preferably appears as a pop-up box 62, which may include the name of the establishment 64, the names and images of people who have used third-party software, such as Facebook™, indicating their presence in the establishment 66 or have “checked-in,” and an option to get more information about the establishment 68.

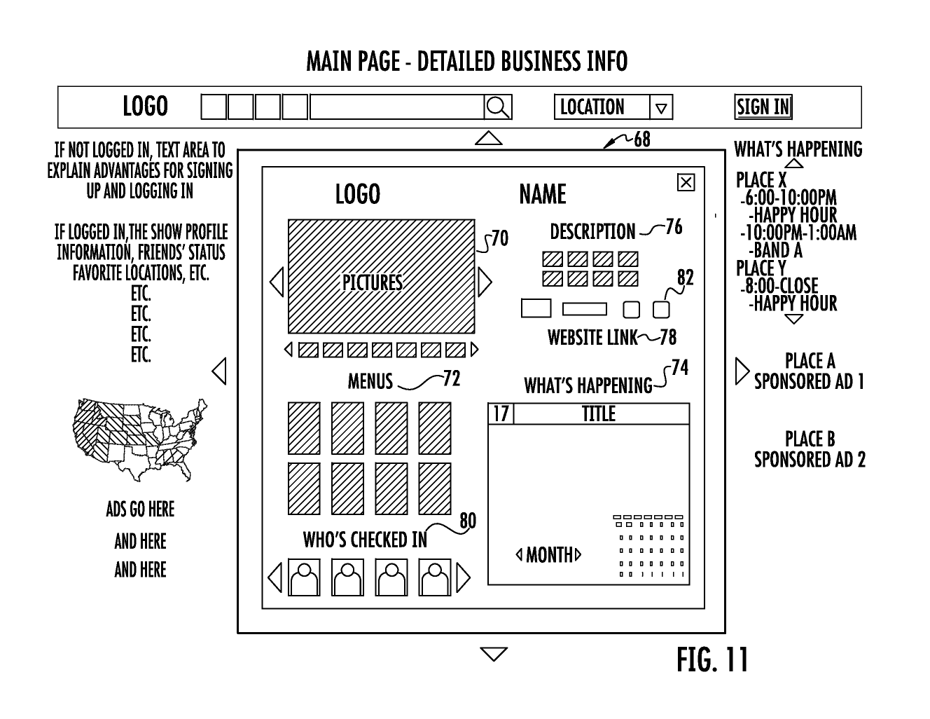

With reference now to FIG. 11, the additional information 68 can be in a form of various pictures pertaining the establishment 70, a restaurant menu 72, events in the establishment 74 including promotions, specials, or sales, and bands or entertainers playing in the establishment, descriptions of the establishment 76, link to the establishment's website 78, people who have “checked-in” 80, and various links to selected websites 82, such as social networking sites and sites showing reviews pertaining to the establishment. It is noted that the information as to the people who have “checked-in” 80 may be due to the linking module 21 detecting relationships between the customer's profile in the customer database 23 and the profile of businesses in the business establishment database 15 (FIG. 1b). Programming codes may be provided to show these relationships in the webpages requested by the browser, such as the webpage shown in FIG. 11.

Individual Account Management

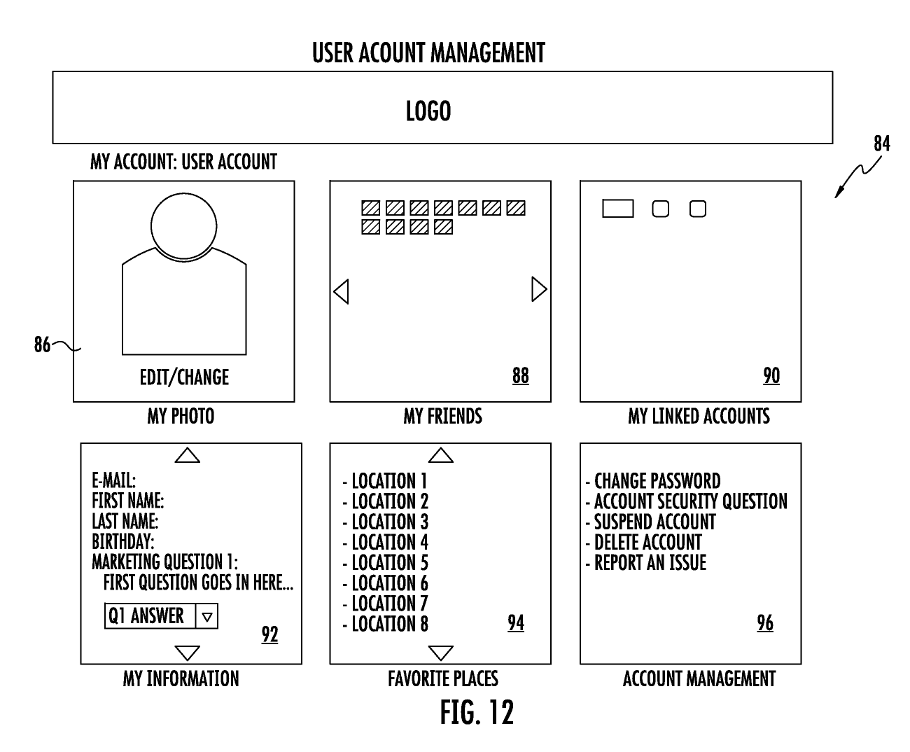

Referring now to FIG. 12, the present invention may allow individual account holders to customize their accounts by accessing the individual user account management webpage 84. For instance, the individual account holders may be allowed to edit their photos or videos 86, add or delete their friends or connections within the system 88, add or delete the webpages that they want to link to their accounts 90, edit their biographical information and security questions and answers 92, save their favorite places 94, and conduct various account management tasks 96, such as changing their passwords and account security questions and answers, suspend their accounts, delete their accounts, or report an issue.

The users may also be allowed to design their home pages, which will be the page that will be displayed upon logging in. For instance, the users may design a home page that displays the business establishments that they have saved as their favorite places. The users may further be allowed to pick a top spot or top establishment among their favorites. The system may rank establishments based on the number of users selecting the establishments as their top spots. The users may further be allowed to add calendar events from various establishments to their own personal calendars. They may also reports these calendar entries on various social media sites.

Business Account Management

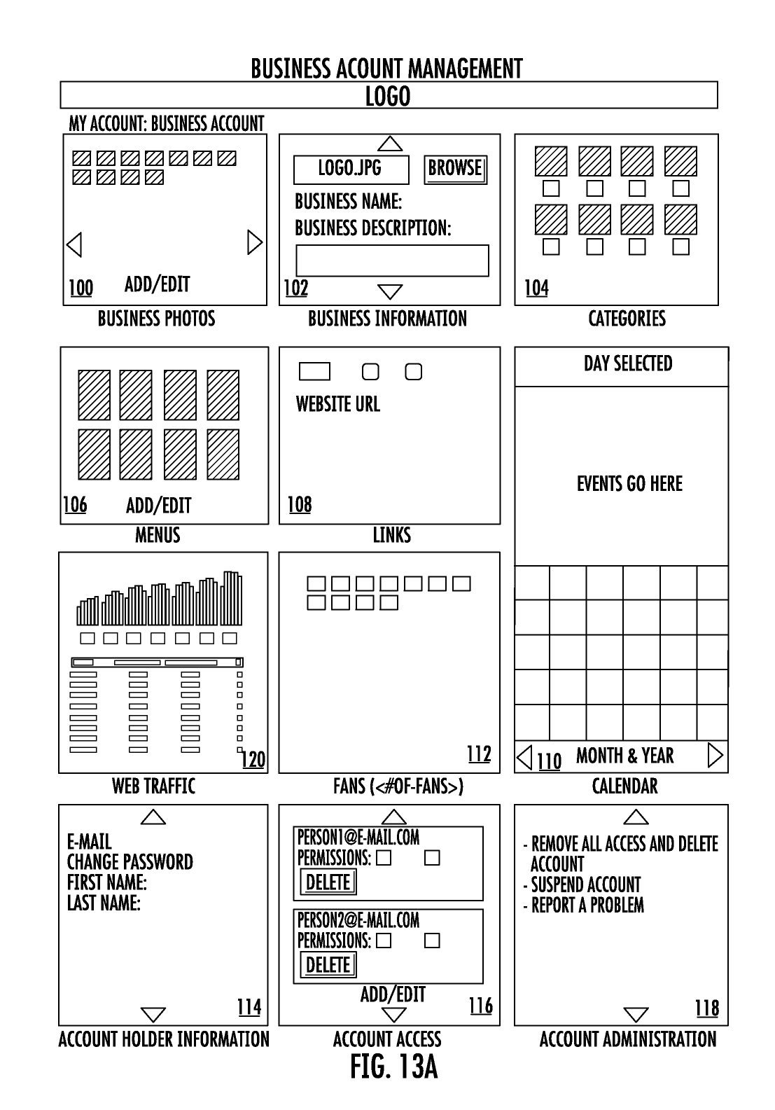

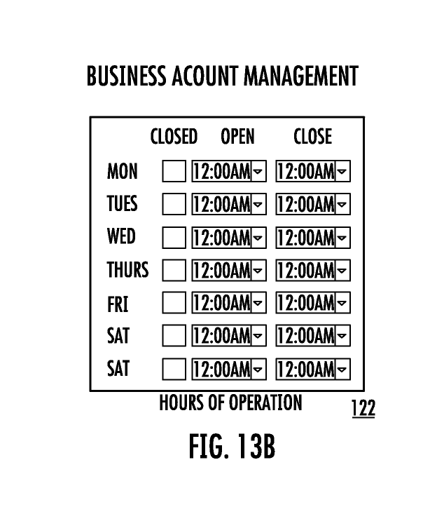

The present invention may also allow business account holders to customize the information being presented to the public regarding their business establishments. For instance, as shown in FIGS. 13a-b, the business account holders may add, delete, or edit the photos or videos pertaining to their business establishments 100. They may change their logo, business description, and other pertinent information about their businesses 102. They may change the categories in which their businesses are listed 104. They may add, delete, or edit the products, services, or menus they are offering to the public 106, the websites they want to link to their accounts 108, their lists of events, calendar entries, or promotions 110, their list of fans or customers who have saved their business establishments as their favorites 112, the information pertaining to their authorized account representatives 114, their business hours 122, and their account access settings 116. It is noted that the list of events, calendar entries, or promotions are preferably programmed so they may be shared. They can preferably be sent as invitations, and the calendar entry can preferably be auto-populated to various calendar software programs of various users so that the event description, event date, and event time may automatically be entered onto the calendars of the various users.

The business account holders may further be given various account administration capabilities 118, such as removing an access or an authorized account, suspending an account, or reporting a problem. It can be appreciated that with certain embodiments of the present invention, businesses can continuously and instantly update their events or “what's happening” section. They can instantly broadcast an event invitation, which may provide a very efficient marketing tool for businesses.

Certain embodiments preferably store various marketing statistics, such as
The number of times a storefront's profile page is displayed for each unique store front;
The number of times an event's details are expanded for each unique store front;
The number of fans for each unique store front;
The number of people that have added each unique store front as their “Top Spot;”.
The amount of time spent at each storefront's profile page for each unique store front (cumulative of all users);
The number of hours and minutes each user has kept each store front as a “Top Spot” for both “cumulative overall time” and “cumulative time since last change” for all users;
The cumulative amount of time spent at each location for all users;
The cumulative amount of time spent within each block for each location for all users;
The cumulative number of store front clicks for each block;
The cumulative number of times a user zooms in for each block;
The cumulative number of times a user zooms out for each block;
The cumulative number of times a user changes the direction of view for each city block;
The cumulative number of times a user chooses “Best View” for each block; and
The number of times a user clicks an external link for each external link for each store front.

These statistics may be accessed by the business account holders. The business accountholders may further view web traffic reports 120, which may be used in analyzing their marketing efforts. The web traffic reports may include, as examples, the number of unique visitors for each month, the number of repeat visitors for each month, and the number of visits for each month. With these statistics and reports, business owners may assess the efficiency of their marketing efforts. They may trace an event that may have generated additional traffic, and they may be able to detect any patterns happening with their businesses, such as seasonal or behavioral patterns, which may be beneficial in growing their businesses.

Artists and Entertainers

The business account holders may be provided with a special dining and entertainment calendar (not shown). This dining and entertainment calendar may include schedules of performances by various artists and entertainers. The performances may vary and may include, stand-up comedy shows, bands, solo performances, and plays. This dining and entertainment calendar can preferably be accessed by artists and entertainers so they can find opportunities to perform. They may also include a feature that allows artists and entertainers to complete and submit an application to perform and allows for communication between the artists or entertainers and the business owners. A performance submission interface (not shown) may be provided and may serve as a form for the artists and entertainers to submit an application.

Flowcharts

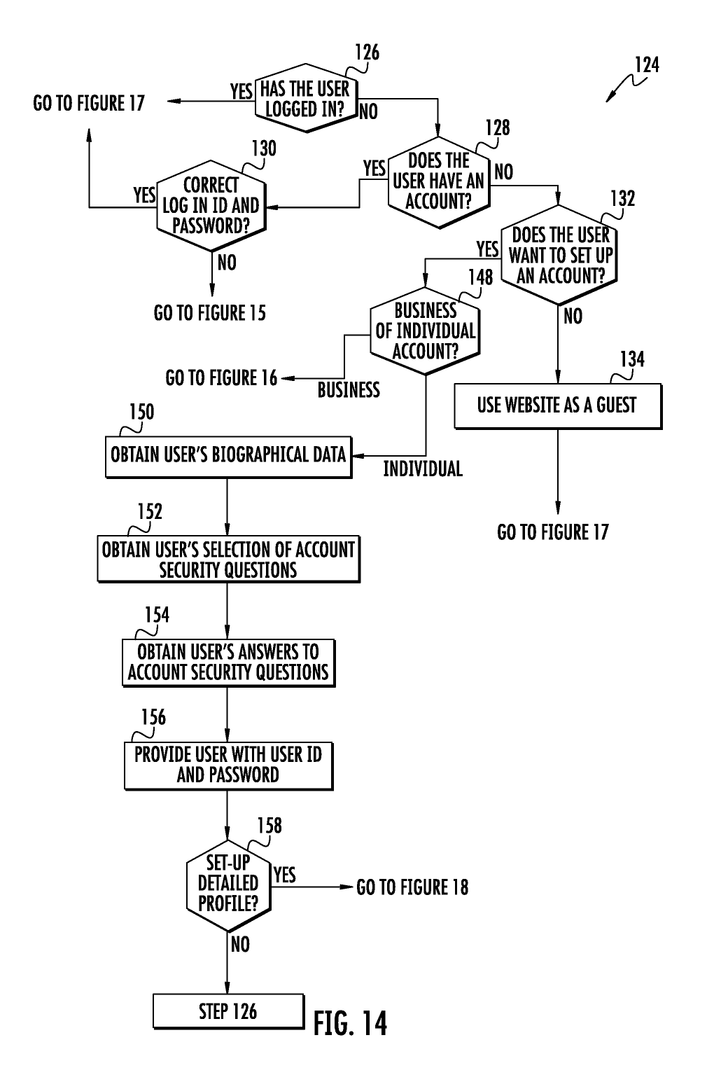

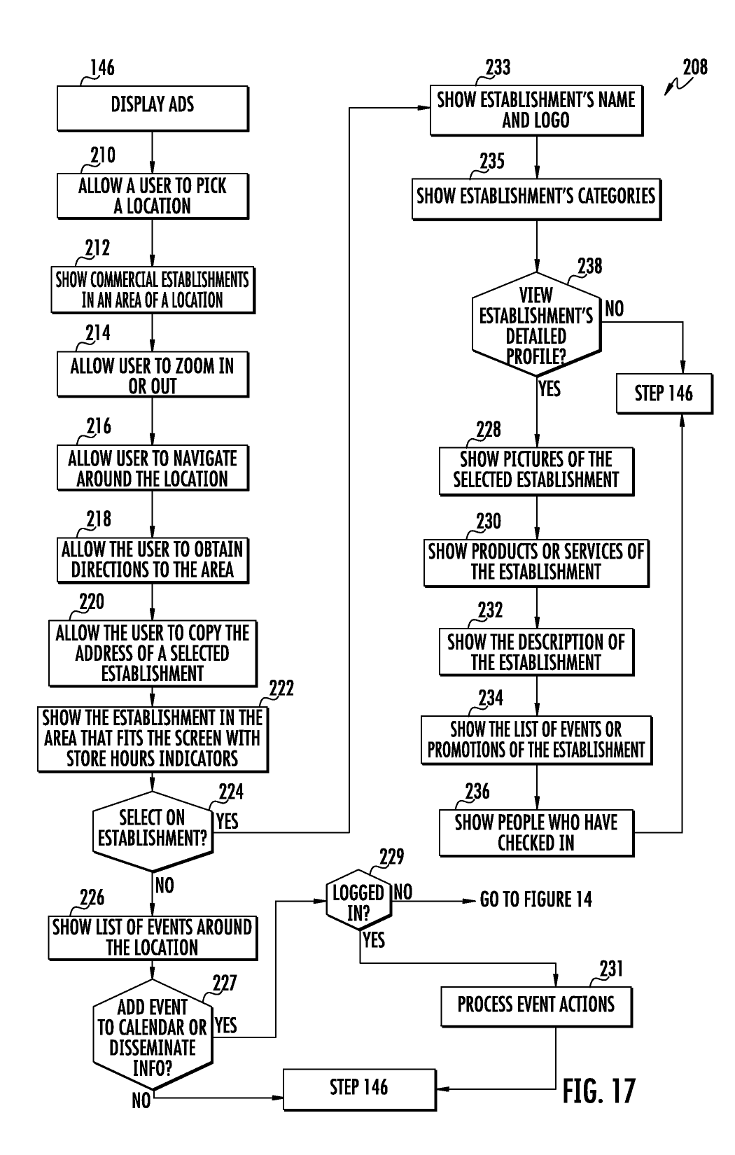

Referring now to FIG. 14, a user log-in flowchart 124 is shown wherein at step 126, the system may check whether the user has logged in. If the user has logged in, the system preferably proceeds to executing the steps in flowchart 208 of FIG. 17. If the user has not logged in, the system may ask the user whether the user has an existing account at step 128. If the user has an existing account, the user may enter the user ID and password, which is verified by the system at step 130. If the user ID and password passes verification, then the system may proceed to executing the steps in flowchart 208 of FIG. 17.

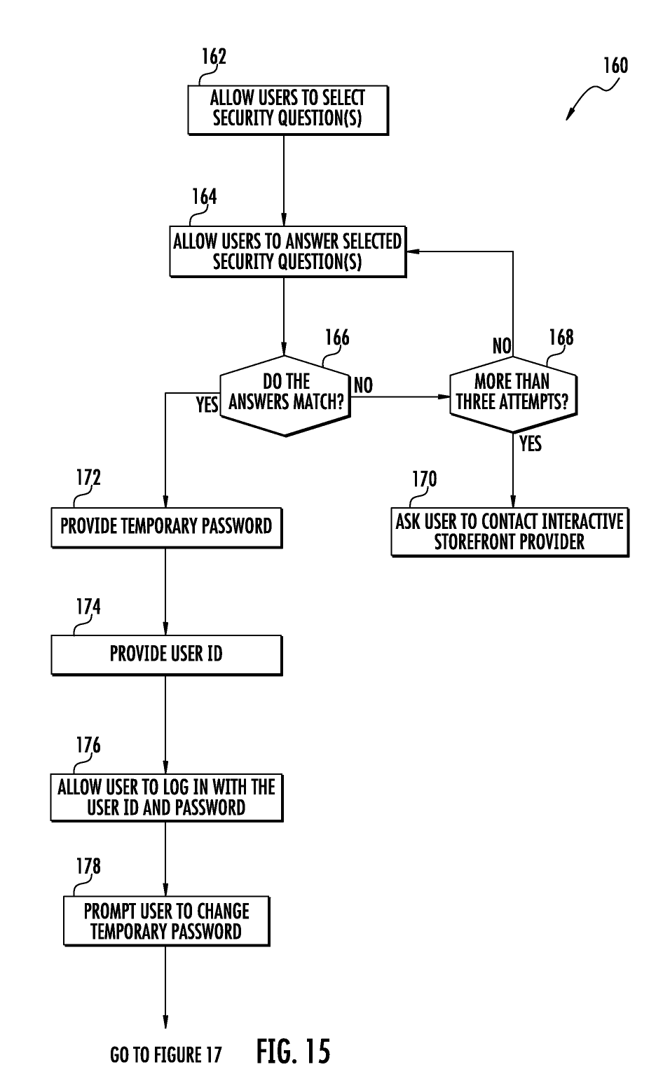

If the user has an existing account, but the user is not able to enter a compliant user ID and password, the system preferably proceeds to executing the steps in flowchart 160 of FIG. 15. If the user does not have any existing accounts, the system preferably prompts the user to set up an account at step 132. If the user chooses not to set up an account, the system preferably logs the user in as a guest at step 134.

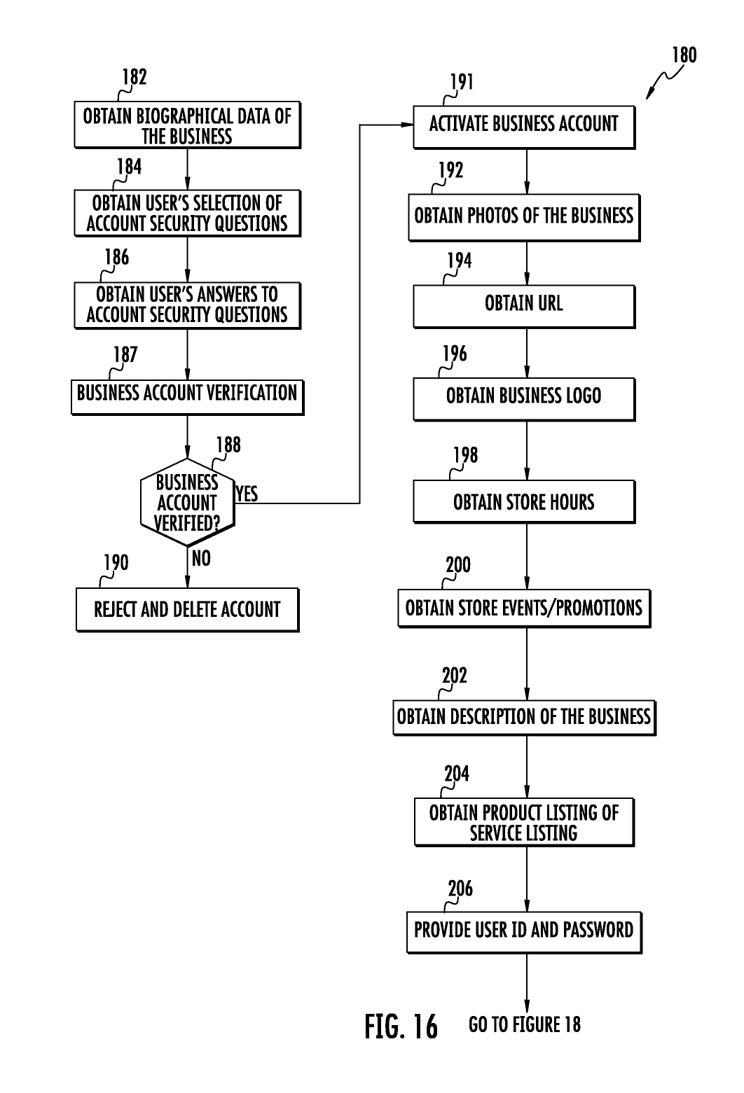

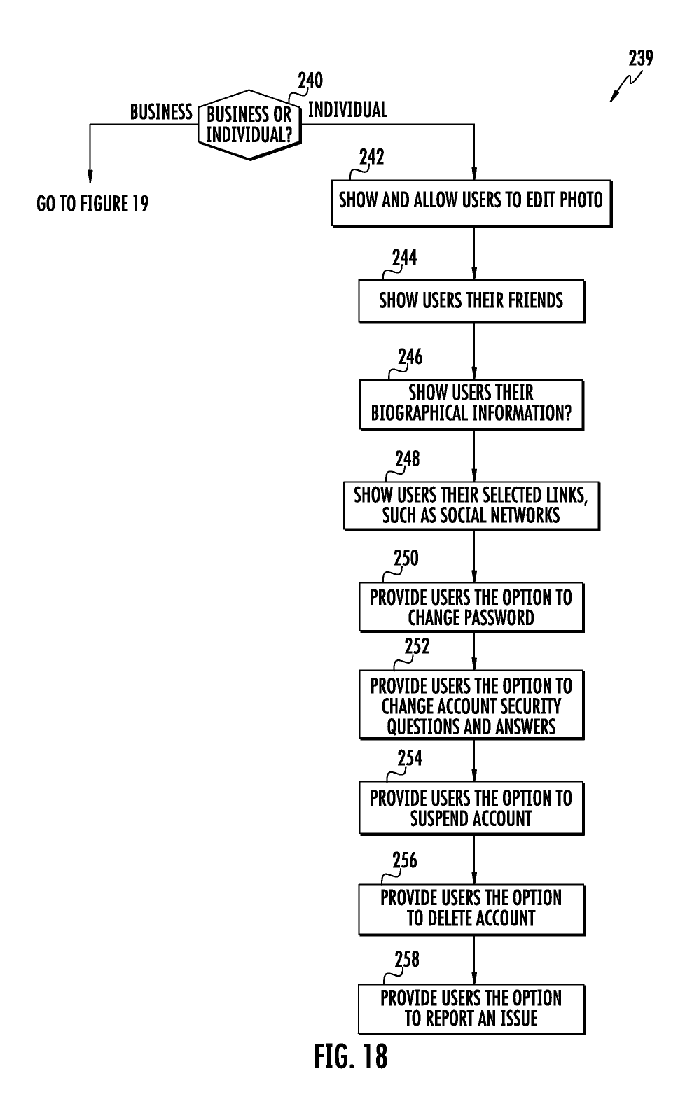

If the user desires to set up an account, the system may allow the user to select between creating a business or individual account (step 148). If the user selects business account, the system preferably executes the steps in flowchart 180 of FIG. 16. If the user selects individual account, the system preferably gathers the user's biographical data (step 150), selection of account security questions (step 152), and corresponding answers to the selected account security questions (step 154). The system may then provide a user ID and password to the user (step 156). Next, the user may be invited to set up a detailed profile (step 158). If the user wants to set up a detailed profile, the system preferably executes the steps in flowchart 239 of FIG. 18. If the user declines setting up a detailed profile, the system preferably goes back to step 126 of flowchart 124.

Referring now to FIG. 15, if the user forgets the valid user ID and password, the system preferably executes the steps in flowchart 160, which includes selecting at least one security question (step 162), answering the selected security question (step 164), and verifying the accuracy of the answer (step 166). If the answer does not match the stored answer, the system may allow the user to re-try for a limited number of attempts, such as three attempts (step 168). If the user continues to be unsuccessful and has reached the maximum allowable number of attempts, the system may prompt the user to contact the interactive storefront provider (step 170).

If the user's answer to the selected security question matches the stored answer, the system may provide the user with a temporary password (step 172) and user ID (step 174). The user may then be allowed to login with the user ID and temporary password (176). The system may ask the user to change the temporary password (step 178).

With reference now to FIG. 16, when the user desires to open a business account, the system preferably executes the steps shown in flowchart 180. The system may obtain the biographical data of the business establishment (step 182). The system may ask the user to select at least one account security question (step 184) and provide a corresponding answer to the account security question (step 186). Next, the system may execute steps to verify the existence of the business and the authority of the person setting up the business account (step 187). This may include background checks, site investigation, research, and interviews with the appropriate persons. The outcome of these steps may be entered into the system, and depending on the outcome, the system may be programmed to reject and delete the account being set up (step 190) or activate the business account (step 192).

Once the business account is activated, the system may proceed to setting up a detailed profile for the business, the system may ask the user for the photos or videos descriptive of or related to the business (step 192), the URL of the business that would provide a link to the website of the business (step 194), any logos of the business (196), the store hours of the business (198), the calendar of events or list of current or future promotions of the business (200), description of the business (202), and a listing of the products or services of the business (204). The listing of the products or services may be in a form of a restaurant menu, product catalog, or schedule of fees depending on the business type. The system may then provide the user with a user ID and password (step 206).

Referring now to FIG. 17, after the user has obtained a user ID and password or the user has expressed to use the website as a guest, the steps of flowchart 208 may be executed. Various advertisements may be displayed to the user at step 146. At step 210, the user may be allowed to pick a location for which a map and information pertaining to local establishments may be provided. A specific area in the location may be displayed as well as the commercial establishments therein (step 212). The user may zoom in or zoom out on the displayed area (step 214) and may navigate through the location provided (step 216). If the user desires, the user may obtain directions to an area of interest within the location (step 218). The user may also select an establishment and copy its address (step 220). The user may be provided with a display of the local establishments with their respective store hours indicator indicating whether the business is open or closed (step 222).

The user may be prompted whether he wants to select an establishment to obtain additional information (step 224). If the user highlights or selects an establishment, the establishment's name and logo (step 233) and the categories the business is listed (step 235). The user may be given an option to view more details about the establishment (step 238). If the user does not want to view more details, the user may see the same screen content but various ads may be displayed on the screen (step 146).

If the user chooses to view more details, pictures of the selected establishment may be provided (step 228) as well as a list of products or services of the establishment (step 230), description of the establishment (step 232), list of events or promotions of the establishment (step 234), and the people who have checked in the establishment (step 236). The user may also be shown some advertisements (step 146). The user may further choose to view his profile or the profile of a business (not shown). Consequently, the steps of FIG. 18 may be executed.

If the user does not select an establishment, the user may be provided with a list of events around the selected location (step 226). The user may be prompted to add the events to the user's own calendar or share the events through various means, such as email or social media (step 227). If the user declines to add or share an event, advertisements may be shown to the user (step 146). If the user indicates he wants to add or share the event, the system may ensure that the user has set up an individual or business account and is not a guest (step 229). Guests are preferably not allowed to add or share an event and will be directed to the account set up steps in FIG. 14. At step 231, users who have set up an account and have entered the appropriate user ID and password, may proceed to adding their desired events to their personal calendars or sharing their desired events.

It can thus be realized that as a guest, the user may be allowed to interact with some of the website features, such as entering a location and viewing some of the maps and storefronts. However, as a guest, the user may not be able to utilize many of the features of the present invention, including obtaining any statistical data or reports that the system has gathered or assembled. The guest user may also not add bookmarked locations, friends or profile pictures.

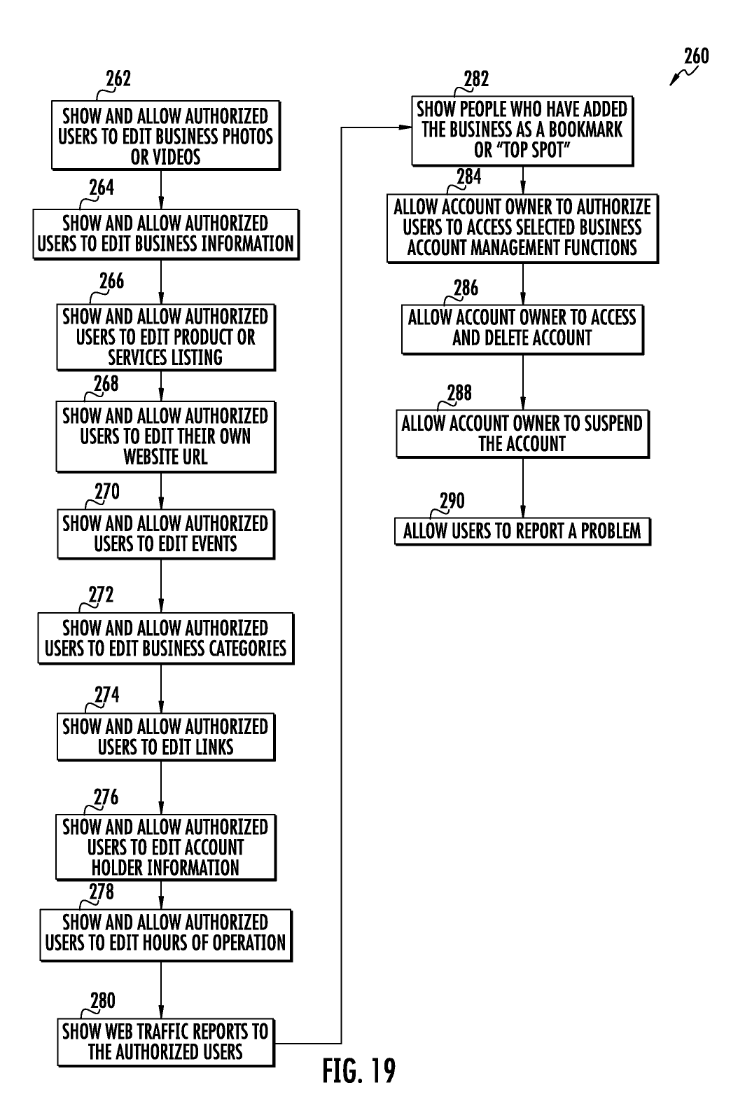

Referring now to FIG. 18, if users desire to view their individual profiles, they may be asked whether they want to view their profiles in their business or individual accounts (step 240). If the users select business accounts, the steps shown in flowchart 260 of FIG. 19 may be executed.

If the users select to view their profiles in their individual accounts, they may be allowed to view or edit their stored photos or videos (step 242), their list of friends (step 244) who also use the systems and methods of the present invention, their biographical information (step 246), their selected links to their favorite websites (step 250), and their security questions and their corresponding answers (step 252). The users may also be allowed to suspend their account (step 254), delete their account (step 256), or report an issue to the provider of the interactive storefront (step 258). The users may be allowed to bookmark their locations, friends, or profile pictures.

Referring now to FIG. 19, flowchart 260 shows the steps that may be executed by the system when users select to view their profiles stored in their business accounts. At step 262, user may be shown the previously stored photos or videos pertaining to their businesses. The users may be allowed to add, delete, or edit the photos or videos. The users may also be shown and allowed to edit their business information (step 264), the listing of their products or services, such as their catalogs, menus, schedule of fees, and the like (step 266), their web address or URL (step 268), their events, promotions, specials or announcements (step 270), the business categories where their businesses are classified (step 272), the links to the websites they like to associate with their profile (step 274), account holder information (step 276), and hours of operation (step 278). The users may further be shown some web data, statistics, or reports such as web traffic reports (step 280). They may be shown the names of the people who have added the establishment in their bookmarks, or have placed the establishment in their “top spot” (step 282). They may also view the people who have indicated their presence in their respective establishments (not shown). The users may further be given some administrative powers, such as limiting or broadening access of certain users to various account features or account management functions (step 284), deleting an account (step 286), suspending an account (step 288), or reporting a problem to the interactive storefront provider (step 290).

It can now be realized that the present invention provides a highly informative map of a selected area of a location and navigation tools that allow for fast and informative navigation. Certain embodiments of the present invention provide a centralized and interactive system for accessing information about a business establishment wherein the manner of access is quick and easy and the information being accessed is current, comprehensive, and practical, such as events going on in the selected area, the business hours of the establishments in the selected area, the people who are in the establishment, the most up-to-date menu, calendar of events, pictures, and link to the establishment's website.

Certain embodiments of the present invention may serve as an effective tool in promoting business establishments, especially those that are not in highly visible locations. In another embodiment, the present invention may store usage statistics that may serve as a helpful marketing tracking tool for business establishments. In yet another embodiment, the present invention may serve as a marketplace for artists and entertainers to look for open time slots for performances and apply to perform in those spots.

In another embodiment, the present invention provides interactive storefronts wherein authorized representatives of business establishments may customize the information about their stores. In certain embodiments, the storefronts are preferably interactive from the consumer standpoint in that they allow consumers to upload their photos or videos, upload their list of friends or invite friends, build their lists of favorite places, pick a top spot among their favorite places in a particular location, their personal calendars, their home screen display preference, their content view, and include links to their social networking sites. It can further be appreciated that certain embodiments of the present invention provide a website that may likely attract both new and repeat visitors who may find the website as a very useful planning tool, especially in making their social and recreational plans. Certain embodiments provide business establishments with a way to complement their websites and instantly update the public with their promotions or events.

Although the description above contains many specifications, these should not be construed as limiting the scope of the invention but as merely providing illustrations of some of the presently preferred embodiments of this invention. For example, the order in which the steps are presented in the flowcharts is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention. The invention is capable of other embodiments and of being practiced and carried out in various ways. The invention is not limited in its application to the details of the construction and to the arrangement of the components set forth in the above description or as illustrated in the drawings.

What is claimed is:

1. A computer-implemented method of providing information about a commercial area, the method comprising:
a. storing in a memory three dimensional images of the commercial area, the commercial area comprising a plurality of business establishments;
b. storing in a memory the business hours of the plurality of the business establishments, the business hours comprising a set of hours when the business establishment is closed for business and a set of hours when the business establishment is open for business;
c. assigning a first business hours indicator to the business establishment during the hours when the business establishment is open;
d. assigning a second business hours indicator to the business establishment during the hours when the business establishment is closed;
e. displaying a three dimensional image of the commercial area; and
f. displaying the plurality of business establishments in the commercial area with their respective business hours indicator.

2. The computer-implemented method of claim 1, further comprising storing in a memory a list of events happening in the commercial area and displaying at least a portion of the list of events.

3. The computer-implemented method of claim 1, further comprising storing in a memory a list of business offerings of the business establishment and displaying at least a portion of the list.

4. The computer-implemented method of claim 1, further comprising storing in a memory a calendar of events of the business establishment, displaying at least a portion of the calendar of events, and allowing a user to browse through the calendar of events.

5. The computer-implemented method of claim 1, further comprising storing in a memory data indicative of a customer having been present in the business establishment and displaying the data.

6. The method of claim 12, further comprising storing georeferenced maps of the area of the commercial location in the computer memory.

7. A system comprising:
a. a computer server connected to a network;
b. a business establishment database in communication with the computer server, the business establishment database adapted to store descriptive data describing a plurality of business establishments;
c. a business user interface module configured to allow a business user to submit descriptive data describing a business establishment over the network, the business user interface module being in communication with the business establishment database, the descriptive data describing a business establishment being transmitted from the business user interface module to the business establishment database;
d. a customer interface module configured to allow a business establishment customer to mark a business establishment;
e. a customer database in communication with the customer interface module and configured to store a customer's profile, the customer's profile comprising a list of marked business establishments via the customer interface module;
f. a linking module connected to the business establishment database and the customer database, the linking module configured to link the marked business establishment to the customer's profile and the customer; and
g. a set of programming codes in communication with the server, the set of programming codes configured to allow a browser that connects to the network and the server to display the descriptive data describing one of the plurality of business establishments and a portion of the customer's profile that marked the business establishment.

8. The system of claim 7, wherein the descriptive data comprises a list of events scheduled for the business establishment, the system further comprising a set of programming codes stored in the server and configured to display the list of events scheduled for the business establishment.

9. The system of claim 7, wherein the descriptive data comprises a list of offerings offered by the business establishment, the system further comprising a set of programming codes stored in the server and configured to display the list of offerings offered by the business establishment.

10. The system of claim 9, wherein the offerings are a menu of food items being served at the business establishment.

11. The system of claim 7, wherein the descriptive data describing a plurality of business establishments comprises three dimensional images of the plurality of business establishments, the system further comprising a set of programming codes stored in the server and configured to display the three dimensional images of the plurality of business establishments.

12. A computer-implemented method of providing information about a performance opportunity, the method comprising:
a. storing in a memory business data pertaining to a plurality of business establishments in a commercial area;
b. storing in a memory a calendar of events that is associated with at least one of the business establishments from the plurality of business establishments, each of the events comprising an event time, an event description, and an event date;
c. allowing the business data and the calendar of events to be viewed from a browser by a user; and
d. providing a performance submission interface to the user, the performance submission interface configured to allow the user to apply to perform for one of the events listed in the calendar of events.

13. The method of claim 12, further comprising
a. storing in a memory the business hours of each of the plurality of business establishments; and
a. allowing the business hours to be viewed from the browser.

14. The method of claim 13, further comprising assigning a store hours indicator that corresponds to at least one of the business establishments from the plurality of business establishments, the store hours indicator being a first type of store hours indicator when the stored business hours of the business establishment indicate the business establishment is closed, the store hours indicator being a second type of store hours indicator when the stored business hours of the business establishment indicate the business establishment is open.

15. The method of claim 12, further comprising:
a. allowing a visitor to the business establishment to indicate their presence in the business establishment;
b. creating and storing a record of the presence of the visitor;
c. sharing the record on a network; and
d. displaying the record with the images of the area of the location on a display device.

16. The method of claim 12, further comprising storing in the computer memory three dimensional views of the area of the commercial location and allowing viewers to navigate the area of the commercial location by looking at the three dimensional views.
